(19) United States
(12) Patent Application Publication
(10) Pub. No.: US 2013/0158910 A1
(43) Pub. Date: Jun. 20, 2013

(54) ELECTRIC POWER MONITOR DEVICE

(71) Applicants: Chi-Cheng Chuang, Kaohsiung City (TW); Ji-Tsong Shieh, New Taipei City (TW)

(72) Inventors: Chi-Cheng Chuang, Kaohsiung City (TW); Ji-Tsong Shieh, New Taipei City (TW)

(21) Appl. No.: 13/417,673

(22) Filed: Mar. 12, 2012

(30) Foreign Application Priority Data
Dec. 20, 2011 (TW) 100147345

(51) Int. Cl. G06F 19/00

(52) U.S. Cl. 702/62; 702/61

(57) ABSTRACT

An electric power monitor device is provided. The electric power monitor device is electrically connected to an alternating current source which supplies electric power to a plurality of under-test current loops. The electric power monitor device comprises a voltage input interface, a voltage measuring unit, a plurality of current measuring components and a processing unit. The voltage input interface is configured to receive an input power source from the alternating current source. The voltage measuring unit is configured to generate voltage values based on the input power source. The current measuring components are capable of adjusting phase configuration based on different phases of the wires of the current loops, and are configured to determine current values of the current loops. The processing unit is configured to calculate an electric power monitor value according to the voltage values and the current values.

This application claims priority to Taiwan Patent Application No. 100147345 filed on Dec. 20, 2011, which is hereby incorporated by reference in its entirety.

### CROSS-REFERENCES TO RELATED APPLICATIONS

Not applicable.

### BACKGROUND OF THE INVENTION

1. Field of the Invention

The present invention relates to an electric power monitor device. More particularly, the electric power monitor device of the present invention can monitor electric power usage conditions of a plurality of current loops having different phase statuses simultaneously.

2. Descriptions of the Related Art

Electric power monitor devices are mainly deployed at customer premises to record electric power usage conditions of the customers for subsequent use. In the prior art, most of electric power monitor devices use separate electric meters to accomplish the purpose of electric power monitoring. However, conventional common electric meters are mostly designed to be able to measure only a single current loop, so the number of electric meters must be increased if a plurality of current loops needs to be monitored simultaneously. Correspondingly, when a plurality of current loops needs to be monitored, the hardware cost of the electric meters will be significantly increased and additional spaces must be used for arrangement of the electric meters. Obviously, this way of measuring current loops by use of a plurality of electric meters leads to a high hardware cost and low flexibility in use.

Accordingly, a single smart electric meter capable of measuring a plurality of current loops simultaneously has been developed in the prior art. However, the prior art single smart electric meter for measuring a plurality of current loops is only able to measure current loops having a same phase (e.g., all being single-phase loops or all being three-phase loops) simultaneously. Therefore, use of the smart electric meter will be considerably restricted when there are current loops having different phases in an under-test environment. Moreover, for both the common electric meters and the smart electric meter described above, phases that can be measured by current measuring components thereof for measuring under-test current loops are all invariable. Therefore, the current measuring components can only be used in wires having particular phases, and likewise, the flexibility in measuring the current loops is relatively low.

Accordingly, an urgent need exists in the art to provide a single electric power measuring device that is capable of measuring a plurality of current loops having different phases simultaneously and capable of adjusting phases of current measuring components according to wires of different current loops so as to reduce the hardware cost and improve the flexibility in use.

### SUMMARY OF THE INVENTION

To solve the aforesaid problem, the present invention provides an electric power monitor device, which is capable of monitoring electric power usage conditions of a plurality of current loops having different phase statuses and capable of adjusting phases of wires of the current loops.

To achieve the aforesaid objective, the present invention provides an electric power monitor device, which is electrically connected to an alternating current source. The alternating current source is configured to supply electric power to a plurality of current loops. The plurality of current loops includes under-test current loops. The electric power monitor device comprises a voltage input interface, a voltage measuring unit, a plurality of current measuring components and a processing unit. The voltage input interface is configured to receive an input power source from the alternating current source. The voltage measuring unit is electrically connected to the voltage input interface and configured to generate a corresponding voltage value based on the input power source.

The plurality of current measuring components include a first current measuring component, and the first current measuring component further comprises a first dismountable current measuring unit and a first phase setting unit. The first dismountable current measuring unit is connected to a first sub-wire of the under-test current loop and configured to measure a first current value of the under-test current loop. The first phase setting unit is configured to set a phase configuration of the first dismountable current measuring unit to correspond to a phase status of the first sub-wire. The processing unit is electrically connected to the voltage measuring unit and the first current measuring component, and is configured to calculate an electric power monitor value according to the voltage value and the first current value of the under-test current loop.

To achieve the aforesaid objective, the present invention further provides an electric power monitor device, which is electrically connected to an alternating current source. The alternating current source is configured to supply electric power to a plurality of current loops. The plurality of current loops includes a first under-test current loop and a second under-test current loop. The electric power monitor device comprises a voltage input interface, a switch, a voltage measuring unit, at lease one first current measuring component, at lease one second current measuring component and a processing unit. The voltage input interface is configured to receive an input power source from the alternating current source. The switch is configured to set a power calculation configuration as one of a three-phase three-wire loop configuration and a three-phase four-wire loop configuration according to the input power source of the alternating current source. The voltage measuring unit is electrically connected to the voltage input interface and configured to generate a corresponding voltage value based on the input power source.

The at lease one first current measuring component comprises a first dismountable current measuring unit and a first phase setting unit. The first dismountable current measuring unit is connected to the first under-test current loop and configured to measure a current value of the first under-test current loop. The first phase setting unit corresponding to the first dismountable current measuring unit is configured to set a phase configuration of the first dismountable current measuring unit to correspond to a phase status of the first under-test current loop. The at lease one second current measuring component comprises a second dismountable current measuring unit and a second phase setting unit. The second dismountable current measuring unit is connected to the second under-test current loop and configured to measure a current value of the second under-test current loop. The second phase setting unit corresponding to the second dismountable current measuring unit is configured to set a phase configuration of the second dismountable current measuring unit to correspond to a phase status of the second under-test current loop. The processing unit is electrically connected to the voltage measuring unit, the at least one first current measuring component and the at least one second current measuring component and is configured to, on the basis of the power calculation configuration, calculate a first electric power monitor value according to the voltage value and the current value of the first under-test current loop and further configured to calculate a second electric power monitor value according to the voltage value and the current value of the second under-test current loop.

According to the above disclosures, the electric power monitor device of the present invention can utilize a plurality of groups of current measuring components to monitor electric power usage conditions of under-test current loops having different phase statuses simultaneously and, by use of phase setting units of the current measuring components, adjust phases of wires of the current loops. In this way, the hardware cost can be reduced and the flexibility in use can be improved for the electric power monitor device.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic view of an electric power monitor device according to a first embodiment of the present invention;

FIG. 2 is a schematic view of an electric power monitor device according to a second embodiment of the present invention;

FIG. 3 is a schematic view of an electric power monitor device according to a third embodiment of the present invention;

FIG. 4 is a schematic view of an electric power monitor device according to a fourth embodiment of the present invention;

FIG. 5 is a schematic view of an electric power monitor device according to a fifth embodiment of the present invention;

FIG. 6 is a schematic view of an electric power monitor device according to a sixth embodiment of the present invention; and

FIG. 7 is a schematic view of an electric power monitor device according to a seventh embodiment of the present invention.

### DESCRIPTION OF THE PREFERRED EMBODIMENT

In the following descriptions, the present invention will be explained with reference to embodiments thereof. However, these embodiments are not intended to limit the present invention to any specific environment, applications or particular implementations described in these embodiments. Therefore, description of these embodiments is only for purpose of illustration rather than to limit the present invention. It shall be appreciated that, in the following embodiments and the attached drawings, elements not directly related to the present invention are omitted from depiction.

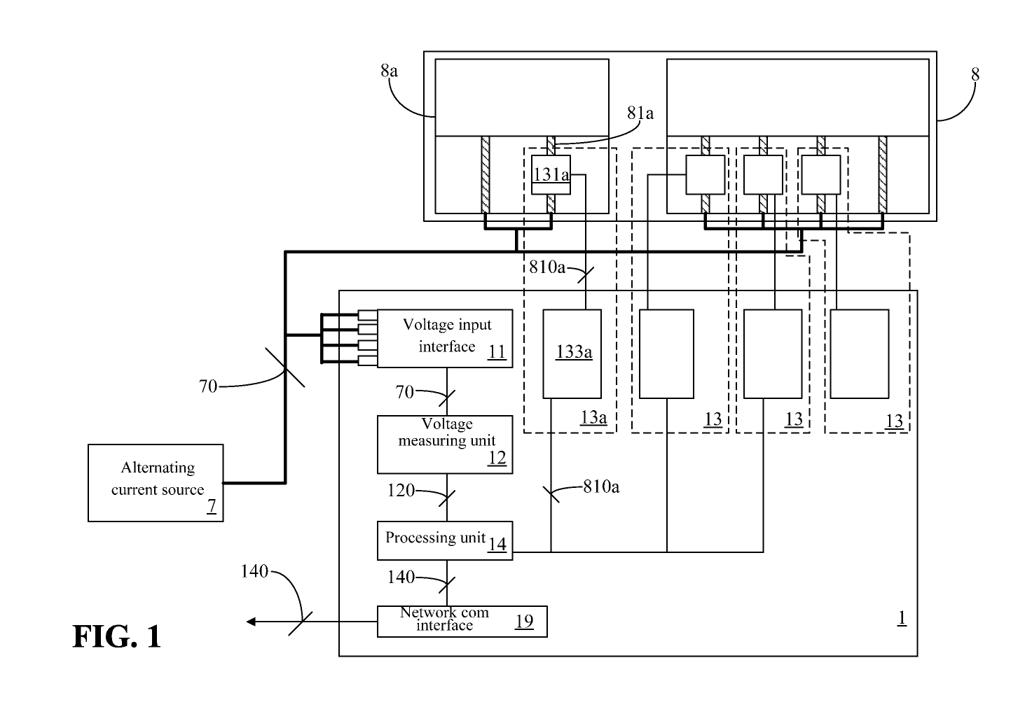

Referring to FIG. 1, there is shown a schematic view of an electric power monitor device 1 according to a first embodiment of the present invention. The electric power monitor device 1 is electrically connected to an alternating current source 7. The alternating current source 7 is configured to supply electric power to a plurality of current loops 8. The current loops 8 include an under-test current loop 8a. The electric power monitor device comprises a voltage input interface 11, a voltage measuring unit 12, a plurality of current measuring components 13 and a processing unit 14. The plurality of current measuring components 13 includes a first current measuring component 13a. The first current measuring component comprises a first dismountable current measuring unit 131a and a first phase setting unit 133a. Hereinbelow, functions of and connection relationships between these components in the first embodiment will be described in detail.

Firstly, the voltage input interface 11 is configured to receive an input power source 70 from the alternating current source 7. The voltage measuring unit 12 electrically connected to the voltage input interface 11 can, on the basis of the input power source 70, determine a corresponding voltage value 120 for use by the electric power monitor device 1 in the subsequent process of calculating information related to electric power by the The voltage value 120 corresponds to a service voltage of the under-test current loop 8a.

On the other hand, the first dismountable current measuring unit 131a is connected to a first sub-wire 81a of the under-test current loop 8a, and is configured to measure a first current value 810a of the under-test current loop 8a. It shall be particularly appreciated that, depending on a type of a voltage inputted to the under-test current loop 8a from the alternating current source 7, the first sub-wire 81a of the under-test current loop 8a will have a corresponding electric phase status. Therefore, the first phase setting unit 133a is configured to set a phase configuration of the first dismountable current measuring unit 131a to correspond to the electric phase status of the first sub-wire 81a.

By way of example, assume that voltage inputted to the under-test current loop 8a from the alternating current source 7 has four types of phases R, S, T and N, and the first sub-wire 81a of the under-test current loop 8a has the R phase. Then, the first phase setting unit 133a is configured to set the phase configuration of the first dismountable current measuring unit 131a to correspond to the R phase status of the first sub-wire 81a so as to guarantee the accuracy of the subsequent calculation of information related to electric power. It shall be particularly emphasized that, as will be readily appreciated by people skilled in the art, the R phase status of the sub-wire of the current loop represents an electric power status when a current flows from a power wire having the R phase to a power wire having the N phase.

In addition, the voltage measuring unit 12, the first dismountable current measuring unit 131a and the first phase setting unit 133a described above may be commonly implemented as a potential transformer, a current transformer and a wire jumper respectively. However, any hardware that is capable of determining voltages, determining currents and setting configurations shall fall within the scope of the present invention, and the hardware as listed above is not intended to limit hardware implementations of the present invention.

The processing unit 14 can calculate information related to electric power after the voltage value 120 and the first current value 810a are determined. In detail, the processing unit 14 is electrically connected to the voltage measuring unit 12 and the first current measuring component 13a. Therefore, after the voltage measuring unit 12 and the first current measuring component 13a transmit the voltage value 120 and the first current value 810a to the processing unit 14 respectively, the processing unit 14 can calculate an electric power monitor value 140 (e.g., an electric power) accordingly.

Thus, as can be known from the descriptions of the aforesaid first embodiment, the electric power monitor device 1 of the present invention is capable of adjusting phase configuration based on different phases of the wires of the current loops so as to obtain information related to electric power of the current loops correctly. It shall be particularly appreciated that, the electric power monitor device 1 according to the first embodiment may further comprise a network communication interface 19, which is configured to transmit the electric power monitor value 140 calculated by the processing unit 14 to a server (not shown) for use in the subsequent process. However, disposition of the network communication interface 19 is optional, but is not intended to limit hardware implementations of the electric power monitor device 1.

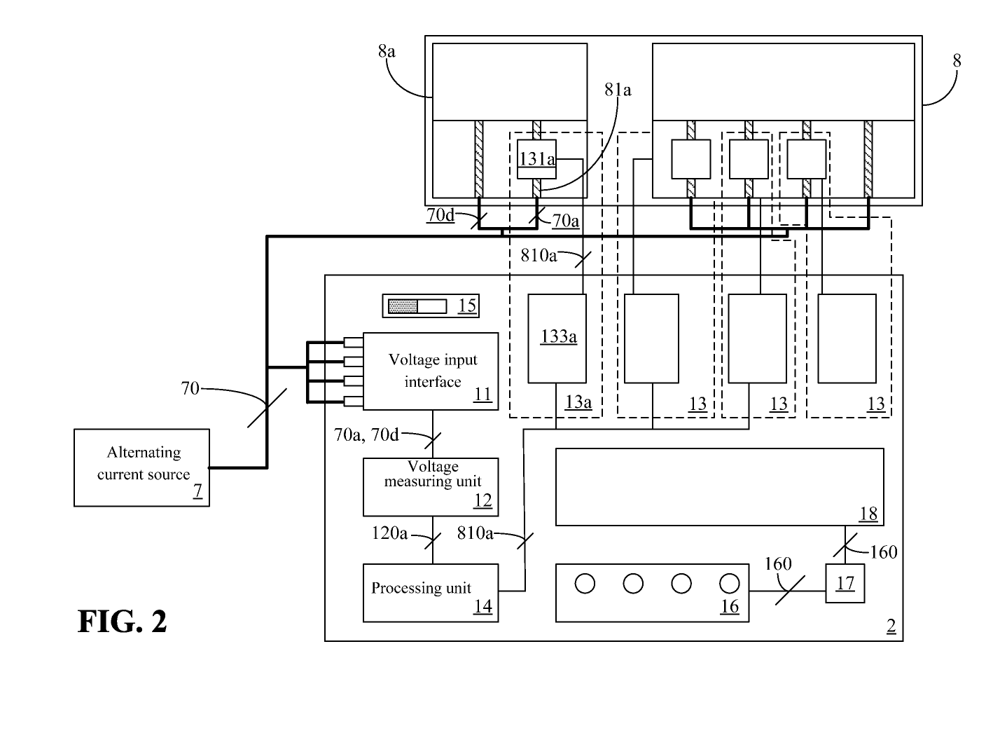

Referring next to FIG. 2, there is shown a schematic view of an electric power monitor device 2 according to a second embodiment of the present invention. The electric power monitor device 2 further comprises a switch 15. It shall be particularly appreciated that, components in the second embodiment bearing the same reference numerals as those of the first embodiment have the same functions, and thus will not be further described again herein. In the second embodiment, the emphasis is laid on corresponding calculating modes of the electric power monitor device when the electric power monitor device is connected to the alternating current source by wires having different phases. In detail, the switch 15 is mainly configured to set a power calculation configuration of the electric power monitor device 2 as one of a three-phase three-wire loop configuration and a three-phase four-wire loop configuration according to the input power source 70 of the alternating current source 7. In the second embodiment, an operating mode of the electric power monitor device 2 when the switch 15 switches to the three-phase four-wire loop configuration and the under-test current loop 8a is a single-phase loop will be explained.

Further speaking, voltages inputted to the three-phase four-wire loop from the alternating current source are mainly divided into four types of power sources. Therefore, the voltage input interface 11 of the present invention may be further configured to receive the four types of power sources having different phases included in the input power source 70. The four types of power sources having different phases at least include a first power wire source 70a and a neutral wire source 70d, and the voltage measuring unit 12 generates a corresponding first phase voltage value 120a accordingly. The first phase voltage value 120a is a differential voltage value between the first power wire source 70a and the neutral wire source 70d, and corresponds to the service voltage of the under-test current loop 8a.

Therefore, when the under-test current loop 8a in the second embodiment is a single-phase loop and only receives the first power wire source 70a and the neutral wire source 70d to form a loop, the processing unit 14 can calculate an electric power monitor value of the single-phase under-test current loop 8a according to the first phase voltage value 120a (i.e., the differential voltage value between the first power wire source 70a and the neutral wire source 70d) and the first current value 810a of the under-test current loop 8a directly.

By way of example, voltages inputted to the three-phase four-wire loop from the alternating current source are mainly divided into four types of power sources R, S, T and N. Therefore, the voltage input interface of the present invention may be further configured to receive the four types of power wire sources R, S, T and N included in the input power source, and the voltage measuring unit can then calculate a first phase voltage value according to a differential voltage value between the R power wire source and the N neutral wire source.

When the under-test current loop is a single-phase loop and only receives the R power wire source and the N neutral wire source to form a loop, the current measuring unit can measure a current value corresponding to the first phase voltage value in the under-test current loop. Then, the processing unit can calculate an electric power monitor value of the single-phase under-test current loop according to the first phase voltage value and the current value of the under-test current loop directly. It shall be particularly appreciated that, the process of calculating information related to electric power according to phases of voltages connected and current values is well known in the art, so no further description will be made again.

On the other hand, because the electric power monitor device of the present invention is capable of measuring electric power information of a plurality of current loops simultaneously, the electric power monitor device must be capable of distinguishing between the different current loops to which the current measuring units are connected so as to avoid errors associated with calculation of electric power information. Therefore, the electric power monitor device 2 according to the second embodiment further comprises an input device 16, a memory 17 and a displaying device 18.

Specifically, the input device 16 is configured to receive a current loop configuration 160 from a user. The current loop configuration 160 is set by the user to arrange the first current measuring component 13a into a measuring component group. In other words, a meaning represented by the measuring component group is that: the current measuring component 13a included therein is used for measuring a same current loop. Then, the electric power monitor device 2 stores the current loop configuration 160 in the memory 17 and, via the displaying device 18, informs the user about the group status used by the first current measuring component 13a to measure the current loop. Thus, the user can set groups of the measuring components via the input device 16, and learn correspondence relationships between the current measuring components and the current loops at present via the displaying device 18.

Thus, as can be known from the descriptions of the aforesaid second embodiment, the electric power monitor device of the present invention may be further configured to, after a power distribution status of the alternating current source to which the electric power monitor device connects is confirmed, determine phases based on which the electric power monitor device calculates information related to electric power via the switch. Furthermore, the user may determine correspondence relationships between the current loops and the current measuring units respectively via the input device and then confirm the correspondence relationships via the displaying device so that the electric power monitor device of the present invention can be used with higher flexibility.

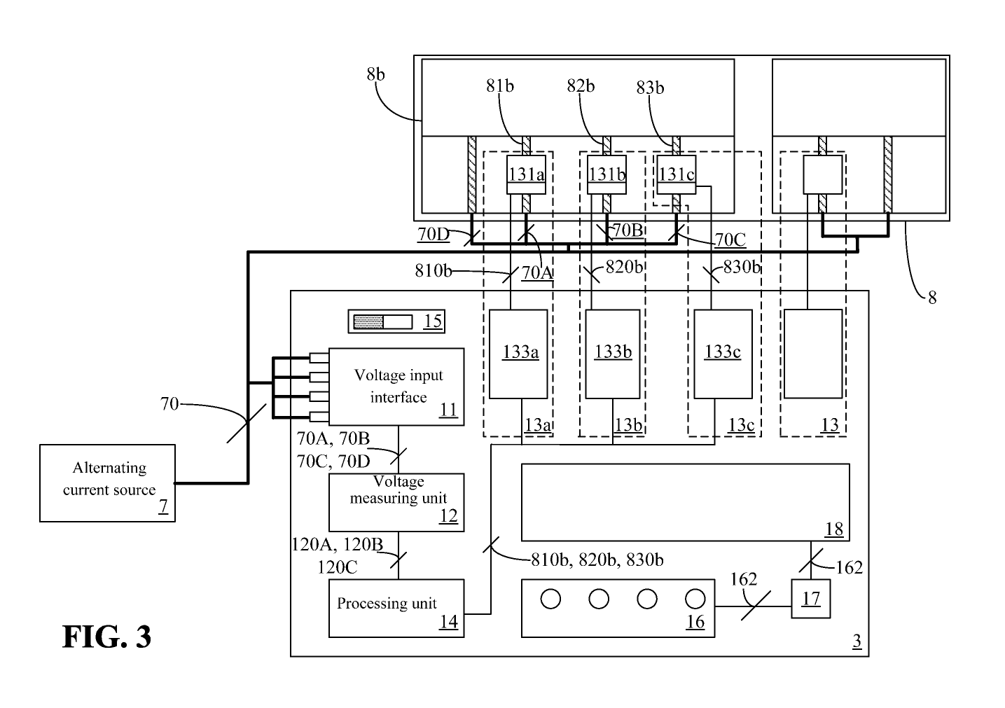

Referring to FIG. 3, there is shown a schematic view of an electric power monitor device 3 according to a third embodiment of the present invention. It shall be particularly appreciated that, components in the third embodiment bearing the same reference numerals as those of the previous embodiments have the same functions, and thus will not be further described again herein. In the third embodiment, the emphasis is also laid on corresponding calculating modes of the electric power monitor device when the electric power monitor device is connected to the alternating current source by wires having different phases. Specifically, the switch 15 is mainly configured to set a power calculation configuration of the electric power monitor device 3 as one of a three-phase three-wire loop configuration and a three-phase four-wire loop configuration according to the input power source 70 of the alternating current source 7. In the third embodiment, an operating mode of the electric power monitor device 3 when the switch 15 switches to the three-phase four-wire loop configuration and an under-test current loop 8b is a three-phase four-wire loop will be explained.

Further speaking, because the under-test current loop 8b is a three-phase four-wire loop, additional current measuring components are needed to measure currents of a plurality of wires. Therefore, the plurality of current measuring components 13 of the electric power monitor device 3 in the third embodiment further includes a second current measuring component 13b and a third current measuring component 13c. The second current measuring component 13b comprises a second dismountable current measuring unit 131b and a second phase setting unit 133b. The third current measuring component 13c comprises a third dismountable current measuring unit 131c and a third phase setting unit 133c.

In the third embodiment, the first dismountable current measuring unit 131a is connected to a first sub-wire 81b of the under-test current loop 8b, and is configured to measure a first current value 810b of the under-test current loop 8b. Depending on a type of a voltage inputted to the under-test current loop 8b from the alternating current source 7, the first sub-wire 81b of the under-test current loop 8b will have a corresponding electric phase status. Therefore, the first phase setting unit 133a is configured to set a phase configuration of the first dismountable current measuring unit 131a to correspond to the electric phase status of the first sub-wire 81b.

Similarly, the second dismountable current measuring unit 131b is connected to a second sub-wire 82b of the under-test current loop 8b, and is configured to measure a second current value 820b of the under-test current loop 8b. Depending on the type of the voltage inputted to the under-test current loop 8b from the alternating current source 7, the second sub-wire 82b of the under-test current loop 8b will have a corresponding electric phase status. Therefore, the second phase setting unit 133b is configured to set a phase configuration of the second dismountable current measuring unit 131b to correspond to the electric phase status of the second sub-wire 82b.

Similarly, the third dismountable current measuring unit 131c is connected to a third sub-wire 83b of the under-test current loop 8b, and is configured to measure a third current value 830b of the under-test current loop 8b. Depending on the type of the voltage inputted to the under-test current loop 8b from the alternating current source 7, the third sub-wire 83b of the under-test current loop 8b will have a corresponding electric phase status. Therefore, the third phase setting unit 133c is configured to set a phase configuration of the third dismountable current measuring unit 131c to correspond to the electric phase status of the third sub-wire 83b.

Next, similarly, voltages inputted to the three-phase four-wire loop from the alternating current source are mainly divided into four types of power sources. Therefore, the voltage input interface 11 of the present invention may be further configured to receive the four types of power sources having different phases included in the input power source 70. The four types of power sources having different phases include a first power wire source 70A, a second power wire source 70B, a third power wire source 70C and a neutral wire source 70D; and accordingly, the voltage measuring unit 12 generates a corresponding first phase voltage value 120A, a corresponding second phase voltage value 120B and a corresponding third phase voltage value 120C.

Similarly, the first phase voltage value 120A is a differential voltage value between the first power wire source 70A and the neutral wire source 70D; the second phase voltage value 120B is a differential voltage value between the second power wire source 70B and the neutral wire source 70D; and the third phase voltage value 120C is a differential voltage value between the third power wire source 70C and the neutral wire source 70D. The first phase voltage value 120A, the second phase voltage value 120B and the third phase voltage value 120C correspond to service voltages of the sub-wires 81b, 82b and 83b of the under-test current loop 8b respectively.

Therefore, when the under-test current loop 8b in the third embodiment is a three-phase four-wire loop and receives the first power wire source 70A, the second power wire source 70B, the third power wire source 70C and the neutral wire source 70D simultaneously to form a loop, the processing unit 14 can calculate an electric power monitor value of the three-phase under-test current loop 8b according to the first phase voltage value 120A, the second phase voltage value 120B, the third phase voltage value 120C and the first current value 810b, the second current value 820b and the third current value 830b of the under-test current loop 8b directly.

By way of example, voltages inputted to the three-phase four-wire loop from the alternating current source are mainly divided into four types of R, S, T and N power sources. Therefore, the voltage input interface of the present invention may be further configured to receive the R power wire source, the S power wire source, the T power wire source and the N neutral wire source included in the input power source; and accordingly, the voltage measuring unit generates a corresponding R phase voltage value, a corresponding S phase voltage value and a corresponding T phase voltage value. The R phase voltage value is a differential voltage value between the R power wire source and the N neutral wire source; the S phase voltage value is a differential voltage value between the S power wire source and the N neutral wire source; and the T phase voltage value is a differential voltage value between the T power wire source and the N neutral wire source. The R, S and T phase voltage values correspond to service voltages of the under-test current loop.

Therefore, when the under-test current loop is a three-phase four-wire loop and receives the R power wire source, the S power wire source, the T power wire source and the N neutral wire source simultaneously to form a loop, the plurality of current measuring components can monitor a first current value corresponding to the R phase voltage value, a second current value corresponding to the S phase voltage value and a third current value corresponding to the T phase voltage value in the under-test current loop. Then, the processing unit can calculate an electric power monitor value of the three-phase under-test current loop according to the R phase voltage value, the S phase voltage value, the T phase voltage value and the first current value, the second current value and the third current value of the under-test current loop directly.

It shall be particularly appreciated that, the process of calculating information related to electric power according to phases of voltages connected and current values is well known in the art, so no further description will be made again herein; and furthermore, as will be readily appreciated by people skilled in the art, a single-phase two-wire loop and a single-phase three-wire loop also each have the N neutral wire and the way of calculating electric power information is just similar to that of the three-phase four-wire loop. Therefore, the way of calculating electric power information for the three-phase four-wire loop when the switch switches to the three-phase four-wire loop configuration may also be used for determining and calculating electric power information of the single-phase loop, and thus will also not be further described again herein.

Because the electric power monitor device of the present invention is capable of measuring electric power information of a plurality of current loops simultaneously, the electric power monitor device must be capable of distinguishing between the different current loops to which the current measuring units are connected so as to avoid errors associated with calculation of electric power information. Similarly, the user can also set groups of the measuring components via the input device 16, and learn correspondence relationships between the current measuring components and the current loops at present via the displaying device 18.

In detail, the input device 16 is configured to receive a current loop configuration 162 from a user. The current loop configuration 162 is set by the user to arrange the first current measuring component 13a, the second current measuring component 13b and the third current measuring component 13c into a measuring component group. In other words, a meaning represented by the measuring component group is that: the current measuring components 13a, 13b and 13c included therein are used for measuring a same current loop. Then, the electric power monitor device 3 stores the current loop configuration 162 in the memory 17 and, via the displaying device 18, informs the user about the group status used by the first, the second and the third current measuring components 13a, 13b and 13c to measure the current loop. Thus, the user can set groups of the measuring components via the input device 16, and learn correspondence relationships between the current measuring components and the current loops at present via the displaying device 18.

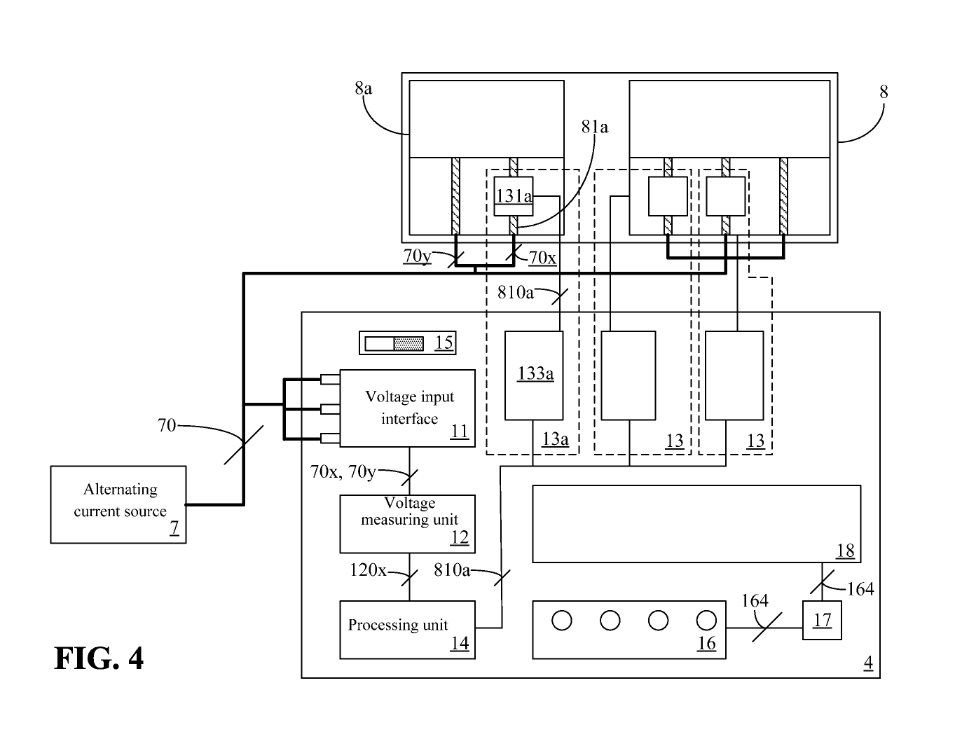

Referring next to FIG. 4, there is shown a schematic view of an electric power monitor device 4 according to a fourth embodiment of the present invention. It shall be particularly appreciated that, components in the fourth embodiment bearing the same reference numerals as those of the previous embodiments have the same functions, and thus will not be further described again herein. In the fourth embodiment, an operating mode of the electric power monitor device 4 when the switch 15 switches to a three-phase three-wire loop configuration and the under-test current loop 8a is a single-phase loop will be explained.

Similarly, voltages inputted to a three-phase three-wire loop from the alternating current source are mainly divided into three types of power sources. Therefore, the voltage input interface 11 of the present invention may be further configured to receive the three types of power sources having different phases included in the input power source 70. The three types of power sources having different phases include a first power wire source 70x and a second power wire source 70y; and the voltage measuring unit 12 generates a corresponding first phase voltage value 120x accordingly. The first phase voltage value 120x is a differential voltage value between the first power wire source 70x and the second power wire source 70y.

Therefore, when the under-test current loop 8a in the fourth embodiment is a single-phase loop and only receives the first power wire source 70x and the second power wire source 70y to Rhin a loop, the processing unit 14 can calculate an electric power monitor value of the single-phase under-test current loop 8a according to the first phase voltage value 120x and the first current value 810a of the under-test current loop 8a directly.

By way of example, voltages inputted to the three-phase three-wire loop from the alternating current source are mainly divided into three types of power sources R, S and T. Therefore, the voltage input interface of the present invention may be further configured to receive the R power wire source, the S power wire source and the T power wire source included in the input power source, and the voltage measuring unit can generate a corresponding R phase voltage value accordingly. The R phase voltage value is a differential voltage value between the R power wire source and the S power wire source.

Then, when the under-test current loop is a single-phase loop and only receives the R power wire source and the S power wire source to form a loop, the current measuring component can monitor a current value corresponding to the R phase voltage value in the under-test current loop. Then, the processing unit can calculate an electric power monitor value of the single-phase under-test current loop according to the corresponding R phase voltage value and the current value of the under-test current loop directly. It shall be particularly appreciated that, the process of calculating information related to electric power according to phases of voltages connected and current values is well known in the art, and thus will not be further described again herein.

Because the electric power monitor device of the present invention is capable of measuring electric power information of a plurality of current loops simultaneously, the electric power monitor device must be capable of distinguishing between different current loops to which the current measuring units are connected so as to avoid errors associated with calculation of electric power information. Similarly, the user may also set groups of the measuring components via the input device 16, and learn correspondence relationships between the current measuring components and the current loops at present via the displaying device 18.

Specifically, the input device 16 is configured to receive a current loop configuration 164 from a user. The current loop configuration 164 is set by the user to arrange the first current measuring component 13a into a measuring component group. In other words, a meaning represented by the measuring component group is that: the current measuring component 13a included therein is used for measuring a same current loop. Then, the electric power monitor device 4 stores the current loop configuration 164 in the memory 17 and, via the displaying device 18, informs the user about the group status used by the first current measuring component 13a to measure the current loop. Accordingly, the user can set groups of the measuring components via the input device 16, and learn correspondence relationships between the current measuring components and the current loops at present via the displaying device 18.

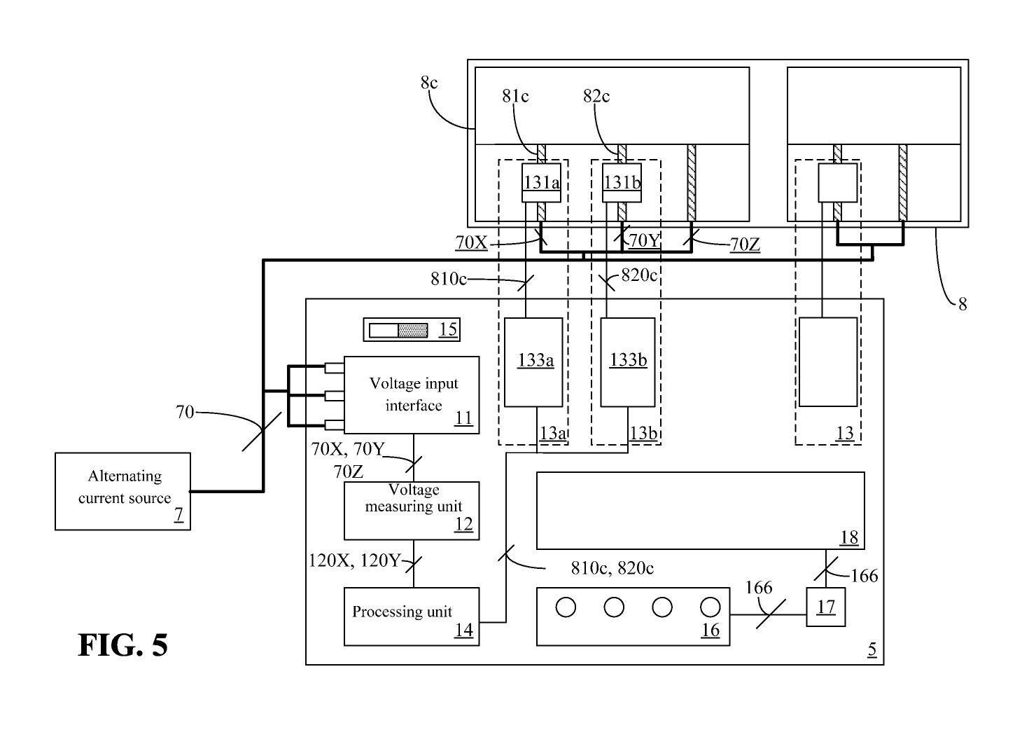

Referring to FIG. 5, there is shown a schematic view of an electric power monitor device according to a fifth embodiment of the present invention. It shall be particularly appreciated that, components in the fifth embodiment bearing the same reference numerals as those of the previous embodiments have the same functions, and thus will not be further described again herein. In the fifth embodiment, an operating mode of the electric power monitor device 5 when the switch 15 switches to a three-phase three-wire loop configuration and an under-test current loop 8c is a three-phase three-wire loop will be explained.

Further speaking, because the under-test current loop 8c is a three-phase three-wire loop, additional current measuring components are also needed to measure currents of a plurality of wires. Therefore, the plurality of current measuring components 13 of the electric power monitor device 5 also includes the second current measuring component 13b. The second current measuring component 13b comprises the second dismountable current measuring unit 131b and the second phase setting unit 133b.

In the fifth embodiment, the first dismountable current measuring unit 131a is connected to a first sub-wire 81c of the under-test current loop 8c, and is configured to measure a first current value 810c of the under-test current loop 8c. Depending on a type of a voltage inputted to the under-test current loop 8c from the alternating current source 7, the first sub-wire 81c of the under-test current loop 8c will have a corresponding electric phase status. Therefore, the first phase setting unit 133a is configured to set a phase configuration of the first dismountable current measuring unit 131a to correspond to the electric phase status of the first sub-wire 81c.

Similarly, the second dismountable current measuring unit 131b is connected to a second sub-wire 82c of the under-test current loop 8c, and is configured to measure a second current value 820c of the under-test current loop 8c. Depending on the type of the voltage inputted to the under-test current loop 8c from the alternating current source 7, the second sub-wire 82c of the under-test current loop 8c will have a corresponding electric phase status. Therefore, the second phase setting unit 133b is configured to set a phase configuration of the second dismountable current measuring unit 131b to correspond to the electric phase status of the second sub-wire 82c.

Similarly, voltages inputted to the three-phase three-wire loop from the alternating current source are mainly divided into three types of power sources. Therefore, the voltage input interface 11 of the present invention may be further configured to receive the three types of power sources having different phases included in the input power source 70. The three types of power sources having different phases include a first power wire source 70x, a second power wire source 70Y and a third power wire source 70Z, and the voltage measuring unit 12 generates a corresponding first phase voltage value 120x and a corresponding second phase voltage value 120Y accordingly.

Similarly, the first phase voltage value 120x is a differential voltage value between the first power wire source 70x and the second power wire source 70Y, and the second phase voltage value 120Y is a differential voltage value between the second power wire source 70Y and the third power wire source 70Z. The first phase voltage value 120x and the second phase voltage value 120Y correspond to service voltages of the sub-wires 81c and 82c of the under-test current loop 8c respectively.

Therefore, when the under-test current loop 8c in the fifth embodiment is a three-phase three-wire loop and receives the first power wire source 70x, the second power wire source 70Y and the third power wire source 70Z simultaneously to form a loop, the processing unit 14 can calculate an electric power monitor value of the three-phase under-test current loop 8c according to the first phase voltage value 120x, the second phase voltage value 120Y, and the first current value 810c and the second current value 820c of the under-test current loop 8c directly.

By way of example, voltages inputted to the three-phase three-wire loop from the alternating current source are mainly divided into three types of power sources R, S and T. Therefore, the voltage input interface of the present invention may be further configured to receive the R power wire source, the S power wire source and the T power wire source included in the input power source, and the voltage measuring unit generates a corresponding R phase voltage value and a corresponding S phase voltage value accordingly. The R phase voltage value is a differential voltage value between the R power wire source and the S power wire source, and the S phase voltage value is a differential voltage value between the S power wire source and the T power wire source. The R and S phase voltage values correspond to service voltages of the under-test current loop.

Then, when the under-test current loop is a three-phase three-wire loop and receives the R power wire source, the S power wire source and the T power wire source simultaneously to form a loop, the plurality of current measuring components can monitor a first current value corresponding to the R phase voltage value and a second current value corresponding to the S phase voltage value in the under-test current loop. Then, the processing unit can calculate an electric power monitor value of the three-phase under-test current loop according to the R phase voltage value, the S phase voltage value, and the first current value and the second current value of the under-test current loop directly. It shall be particularly appreciated that, the process of calculating information related to electric power according to phases of voltages connected and current values is well known in the art, and thus will not be further described again herein.

It shall be particularly appreciated that, when the voltages of the three phases in the three-phase three-wire loop are in a normal balanced status, only two groups of current measuring components are needed to determine electric power information of the under-test current loop. However, when the balanced status of the voltages of the three phases is unstable, electric power information may also be calculated by disposing three groups of current measuring components with each two of them forming a group so that the electric power information of the under-test current loop can be verified.

Because the electric power monitor device of the present invention is capable of measuring electric power information of a plurality of current loops simultaneously, the electric power monitor device must be capable of distinguishing between different current loops to which the current measuring units are connected so as to avoid errors associated with calculation of electric power information. Similarly, the user can set groups of the measuring components via the input device 16, and learn correspondence relationships between the current measuring components and the current loops at present via the displaying device 18.

Specifically, the input device 16 is configured to receive a current loop configuration 166 from a user. The current loop configuration 166 is set by the user to arrange the first current measuring component 13a and the second current measuring component 13b into a measuring component group. In other words, a meaning represented by the measuring component group is that: the current measuring components 13a and 13b included therein are used for measuring a same current loop. Then, the electric power monitor device 5 stores the current loop configuration 166 in the memory 17 and, via the displaying device 18, informs the user about the group status used by the first and the second current measuring components 13a and 13b to measure the current loop. Accordingly, the user can set groups of the measuring components via the input device 16, and learn correspondence relationships between the current measuring components and the current loops at present via the displaying device 18.

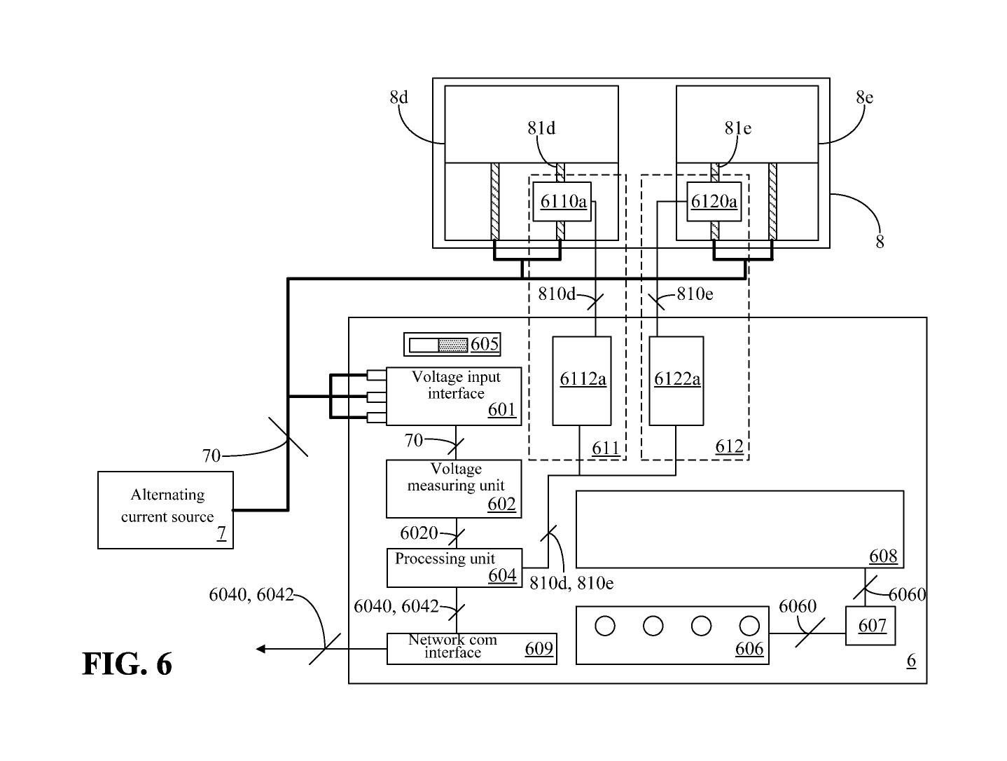

Referring next to FIG. 6, there is shown a schematic view of an electric power monitor device 6 according to a sixth embodiment of the present invention. Similar to the previous embodiments, the electric power monitor device 6 is electrically connected to an alternating current source 7. The alternating current source 7 is configured to supply electric power to a plurality of current loops 8. In the sixth embodiment, the current loops 8 include a first under-test current loop 8d and a second under-test current loop 8e. The electric power monitor device 6 comprises a voltage input interface 601, a voltage measuring unit 602, a switch 605, at least one first current measuring component 611, at least one second current measuring component 612 and a processing unit 604.

It shall be particularly appreciated that, the number of the at least one first current measuring component 611 is determined depending on the under-test current loop to which the at least one first current measuring component 611 corresponds. Further speaking, in the sixth embodiment, the at least one first current measuring component 611 is configured to measure the under-test current loop 8d which is a single-phase loop, so only a current of a single wire needs to be measured. Accordingly, the sixth embodiment requires use of only one first current measuring component 611.

In other words, the at least one first current measuring component 611 only needs to comprise a first dismountable current measuring unit 6110a and a first phase setting unit 6112a corresponding to the first dismountable current measuring unit 6110a. Similarly, because the under-test current loop 8e in the sixth embodiment is a single-phase loop, the number of the at least one second current measuring component 612 may also be only one. Therefore, the at least one second current measuring component 612 only needs to comprise a second dismountable current measuring unit 6120a and a second phase setting unit 6122a corresponding to the second dismountable current measuring unit 6120a.

Firstly, the voltage input interface 601 is configured to receive an input power source 70 from the alternating current source 7. Then, the user adjusts the switch 605 according to the input power source 70 of the alternating current source 7 so that a power calculation configuration of the electric power monitor device 6 can be set to one of a three-phase three-wire loop configuration and a three-phase four-wire loop configuration. In the sixth embodiment, the switch 605 sets the power calculation configuration of the electric power monitor device 6 to the three-phase three-wire loop configuration. Then, the voltage measuring unit 602 electrically connected to the voltage input interface 601 can generate a corresponding voltage value 6020 (e.g., one of the R, S and T phase voltage values described in the aforesaid embodiment of the three-phase three-wire loop) according to the input power source 70 (e.g., one of the R, S and T power wire sources described in the aforesaid embodiment of the three-phase three-wire loop) for use by the electric power monitor device 6 in the subsequent process of calculating information related to electric power.

It shall be particularly emphasized that, for purpose of illustrating concepts of the present invention, the voltage value 6020 is used as service voltages of both of the two single-phase under-test current loops 8d and 8e simultaneously in this embodiment; however, as will be readily appreciated by people skilled in the art, the single-phase under-test current loops 8d and 8e may also use voltage values having different phases of the three-phase three-wire loop depending on different wire arrangements. In other words, different single-phase under-test current loops may use voltage values having different phases, and no further descriptions will be made again herein.

On the other hand, the first dismountable current measuring unit 6110a is connected to a first sub-wire 81d of the first under-test current loop 8d, and is configured to measure a first current value 810d of the under-test current loop 8d. Similarly, depending on a type of a voltage inputted to the under-test current loop 8d from the alternating current source 7, the first sub-wire 81d of the under-test current loop 8d will have a corresponding electric phase status. Therefore, the first phase setting unit 6112a is configured to set a phase configuration of the first dismountable current measuring unit 6110a to correspond to an electric phase status of the first under-test current loop 8d (i.e., the electric phase status of the first sub-wire 81d).

Similarly, the second dismountable current measuring unit 6120a is connected to a first sub-wire 81e of the second under-test current loop 8e, and is configured to measure a first current value 810e of the under-test current loop 8e. Similarly, depending on a type of a voltage inputted to the under-test current loop 8e from the alternating current source 7, the first sub-wire 81e of the under-test current loop 8e will have a corresponding electric phase status. Therefore, the second phase setting unit 6122a is configured to set a phase configuration of the second dismountable current measuring unit 6120a to correspond to an electric phase status of the second under-test current loop 8e (i.e., the electric phase status of the first sub-wire 81e).

After the voltage value 6020, the first current value 810d and the first current value 810e are determined, the processing unit 604 can calculate information related to electric power of the first under-test current loop 8d and the second under-test current loop 8e respectively.

Specifically, the processing unit 604 is electrically connected to the voltage measuring unit 602, the at least one first current measuring component 611 and the at least one second current measuring component 612. Because the power calculation configuration of the electric power monitor device 6 corresponds to the three-phase three-wire loop configuration, the processing unit 604 can, on the basis of the power calculation configuration (i.e., the three-phase three-wire loop configuration), calculate a first electric power monitor value 6040 of the first under-test current loop 8d according to the voltage value 6020 and the first current value 810d and calculate a second electric power monitor value 6042 of the second under-test current loop 8e according to the voltage value 6020 and the first current value 810e after the voltage measuring unit 602, the at least one first current measuring component 611 and the at least one second current measuring component 612 transmit the voltage value 6020, the first current value 810d and the first current value 810e to the processing unit 604 respectively.

Thus, as can be known from the aforesaid descriptions of the sixth embodiment, the electric power monitor device 6 of the present invention is capable of monitoring a plurality of current loops so as to obtain information related to electric power of different current loops simultaneously.

It shall be particularly appreciated that, similarly, because the electric power monitor device of the present invention is capable of measuring electric power information of a plurality of current loops simultaneously, the electric power monitor device must be capable of distinguishing between different current loops to which the current measuring units are connected so as to avoid errors associated with calculation of electric power information. Therefore, the electric power monitor device 6 according to the sixth embodiment may further comprise an input device 606, a memory 607 and a displaying device 608.

Specifically, the input device 606 is configured to receive a current loop configuration 6060 from a user. The current loop configuration 6060 is set by the user to arrange the at least one first current measuring component 611 into a first measuring component group and further arrange the at least one second current measuring component 612 into a second measuring component group. In other words, a meaning represented by the first measuring component group is that: the at least one first current measuring component 611 included therein is used for measuring a same current loop (i.e., the first under-test current loop 8d); and a meaning represented by the second measuring component group is that: the at least one second current measuring component 612 included therein is used for measuring a same current loop (i.e., the second under-test current loop 8e).

Next, the electric power monitor device 6 stores the current loop configuration 6060 in the memory 607 and, via the displaying device 608, informs the user about the current measuring component statuses of the first measuring component group and the second measuring component group. Thus, the user can set groups of the measuring components via the input device 606, and learn correspondence relationships between the current measuring components and the current loops at present via the displaying device 608.

In addition, the electric power monitor device 6 according to the sixth embodiment may also comprise a network communication interface 609. The network communication interface 609 is configured to transmit the first electric power monitor value 6040 and the second electric power monitor value 6042 calculated by the processing unit 604 to a server (not shown) for use in the subsequent processing process. However, disposition of the network communication interface 609 is optional, but is not intended to limit hardware implementations of the electric power monitor device 6.

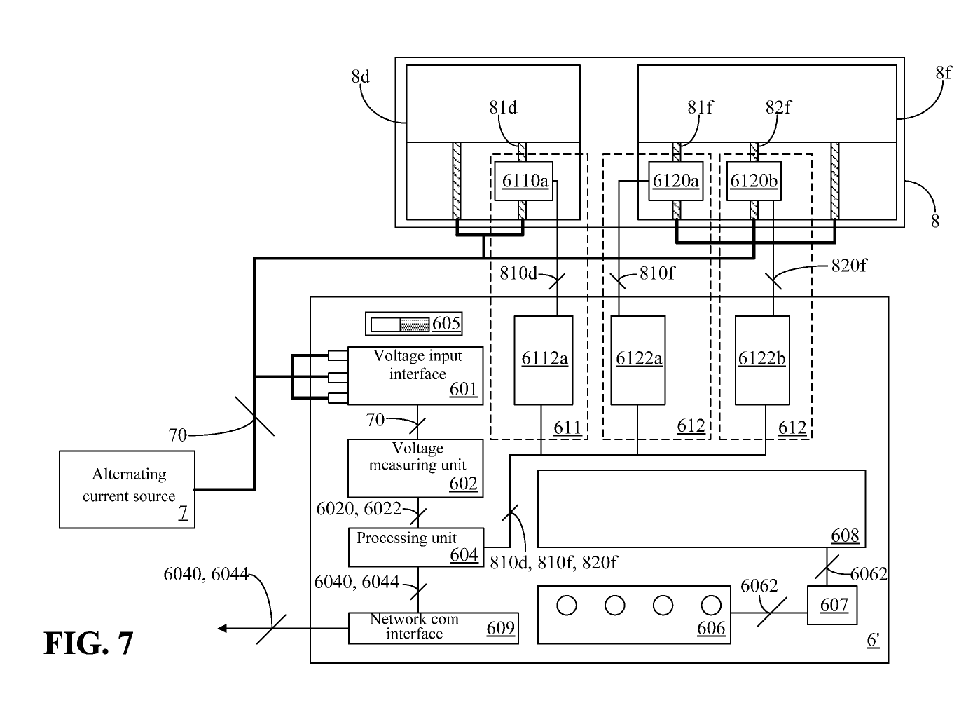

Referring next to FIG. 7, there is shown a schematic view of an electric power monitor device 6′ according to a seventh embodiment of the present invention. It shall be particularly appreciated that, components in the seventh embodiment bearing the same reference numerals as those of the previous embodiments have the same functions, and thus will not be further described again herein.

In the seventh embodiment, an operating mode in which the electric power monitor device 6′ measures a single-phase loop and a three-phase loop simultaneously when the switch 605 sets the power calculation configuration to the three-phase three-wire loop configuration will be explained. Similar to the previous embodiments, the electric power monitor device 6′ is electrically connected to the alternating current source 7. The alternating current source 7 is configured to supply electric power to a plurality of current loops 8. In the seventh embodiment, the current loops 8 include the first under-test current loop 8d and a second under-test current loop 8f.

Similarly, the number of the at least one first current measuring component 611 is determined depending on the under-test current loop to which the at least one first current measuring component 611 corresponds. Further speaking, similarly, the at least one first current measuring component 611 in the seventh embodiment is configured to measure the under-test current loop 8d. Because the under-test current loop 8d is a single-phase loop and only a current of a single wire needs to be measured, the seventh embodiment requires use of only one first current measuring component 611. In other words, the at least one first current measuring component 611 only needs to comprise the first dismountable current measuring unit 6110a and the first phase setting unit 6112a corresponding to the first dismountable current measuring unit 6110a.

On the other hand, because the under-test current loop 8f in the seventh embodiment is a three-phase three-wire current loop, there must be two second current measuring components 612 in order to measure currents. In other words, the at lease one second current measuring component 612 only needs to include two current measuring components: a first one which comprises the first dismountable current measuring unit 6120a and the first phase setting unit 6122a corresponding to the first dismountable current measuring unit 6120a, and a second one which comprises a second dismountable current measuring unit 6120b and a second phase setting unit 6122b corresponding to the second dismountable current measuring unit 6120b.

Next, the voltage measuring unit 602 electrically connected to the voltage input interface 601 can also generate corresponding voltage values 6020 and 6022 (e.g., two of the R, S and T phase voltage values described in the aforesaid embodiment of the three-phase three-wire loop) according to the input power source 70 (e.g., the R, S and T power wire sources described in the aforesaid embodiment of the three-phase three-wire loop) for use by the electric power monitor device 6′ in the subsequent process of calculating information related to electric power.

Similarly in this embodiment, the voltage value 6020 corresponds to a service voltage of the single-phase under-test current loop 8d, and the voltage values 6020 and 6022 correspond to service voltages of the three-phase under-test current loop 8f. However, as also will be readily appreciated by people skilled in the art, the single-phase under-test current loop 8d and the three-phase under-test current loop 8f may also use voltage values having different phases in the three-phase three-wire loop depending on different wire arrangements. Therefore, different single-phase and three-single under-test current loops may use either voltage values having different phases or a same voltage value (e.g., the voltage value 6020 used in this embodiment), and no further descriptions will be made again herein.

On the other hand, similarly, the first dismountable current measuring unit 6110a is connected to the first sub-wire 81d of the first under-test current loop 8d, and is configured to measure the first current value 810d of the under-test current loop 8d. Likewise, depending on the type of the voltage inputted to the under-test current loop 8d from the alternating current source 7, the first sub-wire 81d of the under-test current loop 8d will have a corresponding electric phase status. Therefore, the first phase setting unit 6112a is configured to set a phase configuration of the first dismountable current measuring unit 6110a to correspond to the electric phase status of the first under-test current loop 8d (i.e., the electric phase status of the first sub-wire 81d).

Similarly, the second dismountable current measuring unit 6120a is connected to a first sub-wire 81f of the second under-test current loop 8f, and is configured to measure a first current value 810f of the under-test current loop 8f. Likewise, depending on a type of a voltage inputted to the under-test current loop 8f from the alternating current source 7, the first sub-wire 81f of the under-test current loop 8f will have a corresponding electric phase status. Therefore, the second phase setting unit 6122a is configured to set a phase configuration of the second dismountable current measuring unit 6120a to correspond to an electric phase status of the second under-test current loop 8f (i.e., the electric phase status of the first sub-wire 81f).

In addition, the second dismountable current measuring unit 6120b is connected to a second sub-wire 82f of the second under-test current loop 8f, and is configured to measure a second current value 820f of the under-test current loop 8f. Likewise, depending on the type of the voltage inputted to the under-test current loop 8f from the alternating current source 7, the second sub-wire 82f of the under-test current loop 8f will have a corresponding electric phase status. Therefore, the second phase setting unit 6122b is configured to set a phase configuration of the second dismountable current measuring unit 6120b to correspond to the electric phase status of the second under-test current loop 8f (i.e., the electric phase status of the second sub-wire 82f).

After the voltage values 6020 and 6022, the first current values 810d and 810f and the second current value 820f are determined, the processing unit 604 can calculate information related to electric power of the first under-test current loop 8d and the second under-test current loop 8f respectively. Specifically, the processing unit 604 is electrically connected to the voltage measuring unit 602, the at least one first current measuring component 611 and the at least one second current measuring component 612.

The power calculation configuration of the electric power monitor device 6′ corresponds to the three-phase three-wire loop configuration. Therefore, after the voltage measuring unit 602, the at least one first current measuring component 611 and the at least one second current measuring component 612 transmit the voltage values 6020 and 6022, the first current value 810d, the first current value 810f and the second current value 820f to the processing unit 604 respectively, the processing unit 604 can, on the basis of the power calculation configuration, calculate a first electric power monitor value 6040 of the first under-test current loop 8d according to the voltage value 6020 and the first current value 810d and calculate a second electric power monitor value 6044 of the second under-test current loop 8f according to the voltage values 6020 and 6022, the first current value 810f and the second current value 820f.

As can be known from the above descriptions of the seventh embodiment, the electric power monitor device 6′ of the present invention is capable of monitoring various kinds of current loops having different phases to obtain information related to electric power of the current loops having different phases simultaneously.

It shall be particularly appreciated that, the sixth and the seventh embodiments are provided to illustrate that the electric power monitor device of the present invention is capable of monitoring a plurality of current loops simultaneously, but are not intended to limit combinations of current loops that can be detected.

In detail, the sixth embodiment illustrates monitoring of only a plurality of single-phase current loops, and the seventh embodiment illustrates monitoring of only a single-phase current loop and a three-phase three-wire current loop; however, people skilled in the art may easily employ the technology of the present invention to monitor information related to electric power of other combinations of current loops (e.g., a combination of a single-phase current loop and a three-phase four-wire current loop, a combination of a plurality of three-phase three-wire current loops or a combination of a plurality of three-phase four-wire current loops) according to the above descriptions of the present invention, and this will not be further described again herein.

According to the above descriptions, the electric power monitor device of the present invention can utilize a plurality of groups of current measuring components to monitor electric power usage conditions of under-test current loops having different phase statuses simultaneously and, by use of phase setting units of the current measuring components, adjust phases of wires of the current loops. In this way, the hardware cost can be reduced and the flexibility in use can be improved for the electric power monitor device.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. An electric power monitor device, electrically connected to an alternating current source which supplies electric power to a plurality of current loops, the current loops including an under-test current loop, and the electric power monitor device comprising:
a voltage input interface, being configured to receive an input power source from the alternating current source;
a voltage measuring unit, being electrically connected to the voltage input interface and configured to generate a corresponding voltage value based on the input power source;
a plurality of current measuring components, comprising a first current measuring component, and the first current measuring component further comprising:
a first dismountable current measuring unit, being connected to a first sub-wire of the under-test current loop and configured to measure a first current value of the under-test current loop; and
a first phase setting unit, being configured to set a phase configuration of the first dismountable current measuring unit to correspond to a phase status of the first sub-wire; and
a processing unit, being electrically connected to the voltage measuring unit and the first current measuring component, and configured to calculate an electric power monitor value according to the voltage value and the first current value of the under-test current loop.

2. The electric power monitor device of claim 1, further comprising a switch which is configured to set a power calculation configuration of the electric power monitor device as one of a three-phase three-wire loop configuration and a three-phase four-wire loop configuration according to the input power source of the alternating current source.

3. The electric power monitor device of claim 2, wherein the input power source at least comprises a first power wire source and a neutral wire source, the voltage value further comprises a first phase voltage value, the first phase voltage value is a differential voltage value between the first power wire source and the neutral wire source, the switch is configured to set the power calculation configuration of the electric power monitor device as the three-phase four-wire loop configuration, the under-test current loop is a single-phase loop which receives the first power wire source and the neutral wire source, and the processing unit is further configured to calculate the electric power monitor value according to the first phase voltage value and the first current value of the under-test current loop.

4. The electric power monitor device of claim 3, further comprising:
an input device, being configured to receive a current loop configuration from a user;
a memory, being configured to store the current loop configuration; and
a displaying device, being configured to display the current loop configuration;
wherein the current loop configuration is used for arranging the first current measuring component into a measuring component group.

5. The electric power monitor device of claim 2, wherein the current measuring components further comprise:
a second current measuring component, comprising:
a second dismountable current measuring unit, being connected to a second sub-wire of the under-test current loop and configured to measure a second current value of the under-test current loop; and
a second phase setting unit, being configured to set a phase configuration of the second dismountable current measuring unit to correspond to a phase status of the second sub-wire; and
a third current measuring component, comprising:
a third dismountable current measuring unit, being connected to a third sub-wire of the under-test current loop and configured to measure a third current value of the under-test current loop; and
a third phase setting unit, being configured to set a phase configuration of the third dismountable current measuring unit to correspond to a phase status of the third sub-wire,
wherein the input power source further comprises a first power wire source, a second power wire source, a third power wire source and a neutral wire source, the voltage value further comprises a first phase voltage value, a second phase voltage value and a third phase voltage value, the first phase voltage value is a differential voltage value between the first power wire source and the neutral wire source, the second phase voltage value is a differential voltage value between the second power wire source and the neutral wire source, the third phase voltage value is a differential voltage value between the third power wire source and the neutral wire source, the switch is configured to set the power calculation configuration of the electric power monitor device as the three-phase four-wire loop configuration, the under-test current loop is a three-phase loop which receives the first power wire source, the second power wire source, the third power wire source and the neutral wire source, and the processing unit is further configured to calculate the electric power monitor value according to the first phase voltage value, the second phase voltage value, the third phase voltage value, and the first current value, the second current value and the third current value of the under-test current loop.

6. The electric power monitor device of claim 5, further comprising:
an input device, being configured to receive a current loop configuration from a user;
a memory, being configured to store the current loop configuration; and
a displaying device, being configured to display the current loop configuration,
wherein the current loop configuration is used for arranging the first current measuring component, the second current measuring component and the third current measuring component into a measuring component group.

7. The electric power monitor device of claim 2, wherein the input power source further comprises a first power wire source and a second power wire source, the voltage value further comprises a first phase voltage value, the first phase voltage value is a differential voltage value between the first power wire source and the second power wire source, the switch is configured to set the power calculation configuration of the electric power monitor device as the three-phase three-wire loop configuration, the under-test current loop is a single-phase loop which receives the first phase voltage value and the second phase voltage value, and the processing unit is further configured to calculate the electric power monitor value according to the first phase voltage value and the first current value of the under-test current loop.

8. The electric power monitor device of claim 7, further comprising:
an input device, being configured to receive a current loop configuration from a user;
a memory, being configured to store the current loop configuration; and
a displaying device, being configured to display the current loop configuration,
wherein the current loop configuration is used for arranging the first current measuring component into a measuring component group.

9. The electric power monitor device of claim 2, wherein the current measuring components further comprises the second current measuring component, and the second current measuring component comprises:
a second dismountable current measuring unit, being connected to a second sub-wire of the under-test current loop and configured to measure a second current value of the under-test current loop; and
a second phase setting unit, being configured to set a phase configuration of the second dismountable current measuring unit to correspond to a phase status of the second sub-wire,
wherein the input power source further comprises a first power wire source, a second power wire source and a third power wire source, the voltage value further comprises a first phase voltage value and a second phase voltage value, the first phase voltage value is a differential voltage value between the first power wire source and the second power wire source, the second phase voltage value is a differential voltage value between the second power wire source and the third power wire source, the switch is configured to set the power calculation configuration of the electric power monitor device as the three-phase three-wire loop configuration, the under-test current loop is a three-phase loop which receives the first power wire source and the second power wire source, and the processing unit is further configured to calculate the electric power monitor value according to the first phase voltage value, the second phase voltage value, and the first current value and the second current value of the under-test current loop.

10. The electric power monitor device of claim 9, further comprising:
an input device, being configured to receive a current loop configuration from a user;
a memory, being configured to store the current loop configuration; and
a displaying device, being configured to display the current loop configuration,
wherein the current loop configuration is used for arranging the first current measuring component and the second current measuring component into a measuring component group.

11. The electric power monitor device of claim 1, further comprising:
a network communication interface, being configured to transmit the electric power monitor value to a server.

12. An electric power monitor device, electrically connected to an alternating current source which supplies electric power to a plurality of current loops, the current loops including a first under-test current loop and a second under-test current loop, and the electric power monitor device comprising:
a voltage input interface, being configured to receive an input power source from the alternating current source;
a switch, being configured to set a power calculation configuration as one of a three-phase three-wire loop configuration and a three-phase four-wire loop configuration according to the input power source of the alternating current source;
a voltage measuring unit, being electrically connected to the voltage input interface and configured to generate a corresponding voltage value based on the input power source;
at lease one first current measuring component, comprising:
a first dismountable current measuring unit, being connected to the first under-test current loop and configured to measure a current value of the first under-test current loop; and
a first phase setting unit, corresponding to the first dismountable current measuring unit, being configured to set a phase configuration of the first dismountable current measuring unit to correspond to a phase status of the first under-test current loop;
at lease one second current measuring component, comprising:
a second dismountable current measuring unit, being connected to the second under-test current loop and configured to measure a current value of the second under-test current loop; and
a second phase setting unit, corresponding to the second dismountable current measuring unit, being configured to set a phase configuration of the second dismountable current measuring unit to correspond to a phase status of the second under-test current loop;
a processing unit, being electrically connected to the voltage measuring unit, the at least one first current measuring component and the at least one second current measuring component and configured to, based on the power calculation configuration, calculate a first electric power monitor value according to the voltage value and the current value of the first under-test current loop and further configured to calculate a second electric power monitor value according to the voltage value and the current value of the second under-test current loop.

13. The electric power monitor device of claim 12, further comprising:
an input device, being configured to receive a current loop configuration from a user;
a memory, being configured to store the current loop configuration; and
a displaying device, being configured to display the current loop configuration,
wherein the current loop configuration is used for arranging the at least one first current measuring component and the at least one second current measuring component into a first measuring component group and a second measuring component group respectively.

14. The electric power monitor device of claim 12, further comprising:
a network communication interface, being configured to transmit the first electric power monitor value and the second electric power monitor value to a server.
